(19) United States
(12) Patent Application Publication
(10) Pub. No.: US 2026/0236873 A1
(43) Pub. Date: Aug. 13, 2026

(54) ARTIFICIAL INTELLIGENCE-POWERED CONDUCTION OF STRUCTURED CONVERSATIONS

(71) Applicant: EIGHTFOLD Al INC., Santa Clara, CA (US)

(72) Inventors: Vineet Abraham, Saratoga, CA (US); Sivasankaran Chandrasekar, Menlo Park, CA (US); Juthika Dabholkar, San Francisco, CA (US); Thiyagaraj Thirunavoukkarasu, Bengaluru (IN); Vishesh Kumar, New Delhi (IN); Prabhat Bahukhandi, Greater Noida (IN); Sagar Badiyani, Jamnagar (IN); Rahul Deo Pandey, Bangalore (IN); Ashish Kumar, Purnea (IN); Anuj Singhal, Bengaluru (IN); Hari Kishore Balepalli, Tavarekere (IN)

(21) Appl. No.: 19/282,318

(22) Filed: Jul. 28, 2025

(30) Foreign Application Priority Data
Feb. 10, 2025 (IN) 202541010967

(51) Int. Cl. G06Q 10/0639; G06Q 10/1053; G10L 15/26; H04M 3/493; H04M 3/51

(52) U.S. Cl. CPC G06Q 10/0639; G06Q 10/1053; G10L 15/26; H04M 3/493; H04M 3/5183

(57) ABSTRACT

A computer-implemented method for automated AI-based conversation conduction is disclosed. The method includes generating a URL link for an end user and transmitting it via electronic messaging. Upon activation, a webhook listener detects the event and triggers an API request to a cloud-based telephony system, which establishes a real-time voice session and routes it to an NLP-based voice agent. The NLP-based voice agent synchronizes with an LLM-based AI agent, streaming the conversation and receiving AI-generated responses in real time for delivery to the end user. Simultaneously, the conversation is streamed to an LLM-based observer service implemented as a sidecar process, which detects anomalies using dynamically configurable function plug-ins. A transcript of the session is sent to the LLM-based AI agent for evaluation, and the resulting assessment is transmitted to a reviewer.

### CROSS REFERENCE TO RELATED APPLICATION

This application claims priority to and benefits from Indian Patent Application No. 202541010967, filed on Feb. 10, 2025, entitled “Artificial Intelligence-Powered Conduction of Structured Conversations,” the content of which is incorporated herein by reference in its entirety.

### TECHNICAL FIELD

This disclosure relates to methods and systems for automated conduction of structured conversations.

### BACKGROUND

Scheduling and conducting structured conversations is a critical yet time-consuming component in various operational workflows. Traditional processes require aligning the availability of multiple participants, which becomes increasingly challenging as the volume or complexity of such conversations increases. As a result, many important conversations may not take place as intended due to scheduling conflicts, participant availability constraints, and other operational inefficiencies.

Existing automated solutions for facilitating structured conversations, such as pre-recorded scripts, attempt to address these issues but present significant limitations. Such systems often rely on static, pre-scripted interactions that lack real-time adaptability. They are generally unable to dynamically adjust interactions based on participant input, detect anomalies in the interactions, or address accessibility challenges.

### SUMMARY

A system comprising one or more computers may be configured to perform specific operations or actions through the installation of software, firmware, hardware, or a combination thereof. These components, when in operation, cause the system to execute the required actions. Similarly, one or more computer programs may be designed to perform these operations by including instructions that, when executed by a data processing apparatus, enable the apparatus to carry out the specified actions.

In one general aspect, a method may include generating a URL link for a client device associated with an end user. The method may further involve storing the URL link and associated metadata in a cloud-based storage system and transmitting the URL link to the client device via electronic messaging. Upon detecting activation of the URL link through a webhook listener, the method retrieves selection criteria information and subject-specific attributes of the end user from the cloud-based storage system.

The method may further include generating a structured inquiry template using a machine learning model based on the selection criteria and customizing the structured inquiry template according to the subject-specific attributes of the individual. The structured inquiry template may then be stored in the cloud-based storage system. The method may also involve triggering an API request to a cloud-based telephony system to establish a real-time voice session with the end user. The real-time voice session is dynamically created by the cloud-based telephony system, which allocates memory and computational resources based on system load. A payload of the API request may include a call routing parameter for directing the voice session to an NLP-based voice agent, which retrieves the structured inquiry template from the cloud-based storage system to initiate an automated conversation with the end user.

During the real-time voice session, a synchronized session is established between the NLP-based voice agent and an LLM-based AI agent, continuously streaming the conversation to the LLM-based AI agent. The NLP-based voice agent receives AI-generated responses to the end user's voice input in real time and delivers these responses dynamically, adjusting the conversation flow as needed. The method may further include transcribing the real-time voice session using a speech-to-text service and sending an asynchronous request to the LLM-based AI agent to analyze the transcribed voice session and generate an evaluation. Upon completion of the real-time voice session, the system deactivates the URL link and transmits the evaluation to a reviewer.

In some implementations, the method may include streaming the real-time voice session simultaneously to an LLM-based observer service, which functions as a sidecar process for detecting anomalies. The observer service may incorporate APIs that allow for dynamically adding, removing, or modifying function plug-ins, where each function plug-in defines one or more anomaly detection routines. The observer service may also apply a configurable priority parameter, determining whether a detected anomaly should trigger immediate real-time alerts and intervention or be processed asynchronously without disrupting the live conversation.

The system may support various anomaly detection mechanisms, including an off-topic response detector that identifies deviations from the structured inquiry template, a speech pattern analyzer that detects speech disorders or inconsistencies, and a fraud detection module that monitors for multiple speakers or voice inconsistencies indicative of unauthorized assistance. Upon detecting an anomaly, the observer service may transmit a correction event to the LLM-based AI agent, instructing it to modify the conversation flow in real time.

The observer service may further implement a response latency threshold, triggering an instruction to the NLP-based voice agent to rephrase a question or prompt the end user for clarification if prolonged pauses exceed a predefined threshold. Additionally, the observer service may evaluate acoustic features of the voice input and, upon detecting an impairment or inconsistency, activate an accessibility accommodation mode. This mode may adjust the conversation delivery by reducing speech rate, simplifying question phrasing, or offering a text-based alternative to ensure inclusivity.

Furthermore, the observer service may apply a dynamic scoring mechanism to classify detected anomalies by severity level. If the cumulative anomaly score surpasses a predefined threshold indicative of fraudulent or non-cooperative behavior, the system may initiate an interview termination sequence or escalate the session for human review. The method may also include real-time skill and experience assessment, where the LLM-based AI agent or observer service identifies gaps in the end user's responses and dynamically adjusts the structured inquiry template to probe missing but relevant skills.

A matching evaluation module may analyze data from multiple conversations to rank end users based on their alignment with predefined selection criteria. If multiple end users exhibit substantially similar high match levels, the system may trigger an additional automated session, generating refined or supplementary inquiries to further differentiate among them. These follow-up sessions help optimize candidate evaluation by focusing on key differentiating factors.

The described implementations may be realized in hardware, software, or a combination thereof, including computer-readable storage media containing instructions that, when executed by a processor, enable the described operations. Corresponding computer systems, apparatuses, and computing devices may be configured to execute the disclosed methods, ensuring scalability, adaptability, and automation in AI-powered conversational assessment.

### BRIEF DESCRIPTION OF THE DRAWINGS

FIG. 1 illustrates a traditional manual screening process.

FIG. 2 illustrates an exemplary system diagram of AI-powered Recruiting (AIR) agent for automated screening, in accordance with some embodiments.

FIG. 3 illustrates an exemplary cross-functional diagram of automated screening using AIR, in accordance with some embodiments.

FIG. 4 illustrates an exemplary set of functionalities implemented in AIR to improve the quality and efficiency of automated screening, in accordance with some embodiments.

FIGS. 5A-5C illustrate an exemplary method of automated screening using AIR in accordance with some embodiments.

FIG. 6 illustrates an example AIR architecture in which the above-mentioned AIR agent is deployed, in accordance with some embodiments.

FIG. 7 illustrates an example computing device in which any of the embodiments described herein may be implemented.

### DETAILED DESCRIPTION

The description is presented to enable any person skilled in the art to make and use the embodiments and is provided in the context of a particular application and its requirements. Various modifications to the disclosed embodiments will be readily apparent to those skilled in the art, and the general principles defined herein may be applied to other embodiments and applications without departing from the spirit and scope of the present specification. Thus, the specification is not limited to the embodiments shown but is to be accorded the widest scope consistent with the principles and features disclosed herein.

In various embodiments, the disclosed system provides an automated AI-based conversation conduction framework that enables real-time, dynamic interactions between an end user and an AI-driven conversational agent. The system is designed to support structured inquiry processes across a variety of use cases, including automated assessments, customer interactions, eligibility verification, and other AI-driven engagements requiring structured information gathering and evaluation. The system leverages cloud-based telephony services, natural language processing (NLP)-based voice agents, and large language models (LLMs) to conduct adaptive, real-time conversations. Additionally, an observer service, implemented as a sidecar process, enhances the interaction by detecting anomalies and refining conversation flow through dynamically configurable function plug-ins.

For clarity and illustrative purposes, the following description presents an AI-driven screening process as a specific implementation example. However, it should be understood that the disclosed system and methods are not limited to this particular application and may be adapted to various AI-driven structured inquiry and evaluation processes across different domains.

To overcome the technical challenges associated with conventional manual screening processes or pre-recorded screening processes, as described in the background section, embodiments disclosed herein provide a scalable AI-driven candidate screening system that enables real-time, on-demand interview sessions without requiring human interviewer intervention. The system leverages cloud-based telephony services to initiate voice calls to candidates upon activation of a unique interview link, dynamically allocating computational resources to support concurrent interview sessions. An NLP-based voice agent conducts the interview by retrieving a structured interview template, while an LLM-based AI agent continuously processes and analyzes candidate responses in real time, dynamically adjusting the conversation flow based on contextual cues.

In a system utilizing a single LLM-based agent, the AI model may exhibit excessive receptiveness, making it susceptible to manipulation, where a user can unduly influence the direction of the conversation. To enhance the effectiveness, reliability, and robustness of the screening process, the disclosed system incorporates an observer module-a parallel LLM-based supervisory service that operates independently alongside the primary conversation pipeline. This module continuously monitors the interaction, detecting anomalies such as off-topic responses, speech irregularities, language mismatches, and fraudulent behavior (e.g., multiple individuals attempting to answer on behalf of a single candidate). Upon identifying an anomaly, the observer module dynamically intervenes by injecting corrective prompts into the LLM-based AI agent, adjusting the questioning strategy, or, in cases of severe inconsistencies, rerouting the candidate to an alternative screening method. This architecture ensures a more controlled, unbiased, and secure AI-driven interview process.

In addition, by integrating real-time voice processing, adaptive AI-driven conversation management, and anomaly detection, the disclosed system significantly enhances hiring efficiency, candidate accessibility, and fraud prevention in automated recruitment workflows. The scalable architecture ensures that an unlimited number of candidates can be screened in parallel, optimizing resource allocation while maintaining a high level of interaction quality, fairness, and compliance with hiring protocols.

This disclosure provides multiple technical benefits. First, by integrating cloud-based storage systems, cloud-based telephony systems, and multiple AI agents serving different purposes, embodiments disclosed herein leverage distributed computation across remotely coupled systems to tackle a resource-consuming task. This enables the instantaneous conduction of an automated structured conversation and the ability of conducting different, customized conversation in parallel.

Second, disclosed methods and systems enhance the performance of LLM models by creating multiple AI agents and using the output of some of the AI agents as input to other AI agents, (also referred to as observer services), to perform functionalities such as evaluation, cross-checking, and text-to-speech conversion. By employing the observer service with real-time anomaly detection, the system ensures the integrity and fairness of AI-driven structured conversations and mitigates potential biases and limitations that one AI model may possess due to the specific training data set and training method used. By employing the coordination of multiple AI agents, the methods and systems also significantly reduces the amount of training needed to eliminate such biases and limitations from a single LLM model. This is because, for example, a special-purpose AI model for the observer services is specifically trained to perform the task of observing a conversation for abnormal behavior and can achieve better performance for its designated functionality with a relatively small amount of training or fine-tunning, especially as compared with implementing such functionalities with a general-purpose LLM model. Furthermore, the integration of multiple AI agents provides enhanced explainability by revealing and evaluating intermediate results of the workflow.

Third, these methods and systems enhance the modularity and adaptability of AI-driven candidate screening through the observer service, which is designed as a pluggable, extensible framework for real-time and asynchronous anomaly detection. Instead of a monolithic, pre-defined anomaly detection system, the observer service provides APIs for dynamically adding or removing function plug-ins, enabling customization of detection mechanisms based on evolving screening needs. Each plug-in may specify its priority level, dictating whether it requires immediate intervention in the conversation flow or allows for a delayed, asynchronous response.

The observer service prioritizes anomaly detection based on the urgency of intervention. High-priority detections, such as off-topic responses and fraudulent behavior, require immediate correction to maintain interview integrity. The system can dynamically rephrase questions, prompt candidates for clarification, or escalate suspicious cases involving voice inconsistencies or multiple speakers for human review or termination. Lower-priority detections, including speech disorder recognition and sentiment analysis, are processed asynchronously to enhance post-interview evaluation without disrupting the conversation. Speech impairments are logged for potential accessibility accommodations, while engagement patterns inform candidate assessment. By orchestrating detection modules based on priority, the observer service ensures real-time interventions where necessary while leveraging asynchronous insights for long-term system improvements. This modular, API-driven architecture allows seamless integration of new detection mechanisms without interfering with ongoing interviews, ensuring scalability, adaptability, and continuous optimization of the automated screening process.

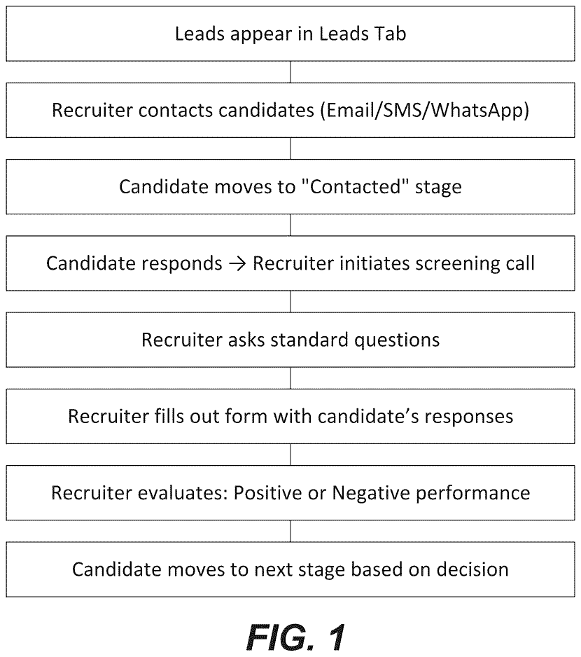

FIG. 1 illustrates a traditional manual screening process. This process generally begins with the sourcing partner or agent gathering potential candidate leads. At this stage, recruiters need to manually sift through and evaluate these leads. Once the recruiter identifies well-suited candidates, they reach out via email, SMS, or WhatsApp. Because all communication is done manually, response times can vary, and recruiters must keep track of their outreach efforts without any automated system to ensure consistency. As a result, some candidates may receive repeated messages, while others may be unintentionally ignored. This lack of automation makes the process slow, inefficient, and inconsistent.

After a recruiter initiates contact, the candidate moves to a “Contacted” stage in the hiring pipeline. However, since recruiters need manually update the system, there is a risk of errors such as missing updates or misclassifications. A failure to correctly record the status of candidates can lead to confusion, redundant efforts, and difficulty in assessing overall recruitment progress.

If a candidate responds positively, the recruiter schedules and conducts a screening call. This step often causes delays due to the manual coordination involved in setting up calls, especially when dealing with a high volume of applicants. Because the screening needs to fit both the candidate's and the recruiter's schedules, scheduling requires confirmation from both sides. Typically, one party provides multiple time slots, the other confirms or proposes alternatives, and then the first party finalizes the arrangement. This back-and-forth process is extremely inefficient, leading to unnecessary delays and missed opportunities. Additionally, since there is no automated scheduling system in place, follow-ups may be overlooked, resulting in a disorganized and inconsistent process.

In contrast, the AI-powered Recruiter (AIR) system described below eliminates the need for manual scheduling confirmations. Unlike human recruiters, AIR does not require availability coordination, as the voice-screening process is conducted by AI agent instances that are essentially infinite (e.g., dynamically instantiated and always available). This allows candidates to initiate the screening process at their convenience, without waiting for confirmation from a recruiter. By removing the dependency on human availability, this design significantly streamlines the screening process, enabling faster and more efficient candidate assessments while improving the overall recruitment experience.

In the traditional process, during the screening call, the recruiter asks the candidate a set of questions to assess their suitability for the role. Although these questions may be mostly standardized, they are still subject to human inconsistency, where different recruiters may evaluate responses differently or have inherent biases. Additionally, without an automated recording or structured input system, key details may be missed, and evaluations may vary significantly from recruiter to recruiter.

Following the interview, the recruiter manually fills out a form detailing the candidate's responses. This documentation process is both time-consuming and error-prone, as recruiters must rely on notes taken during the call and ensure accurate data entry. The lack of a structured and automated input system can lead to incomplete, inconsistent, or even lost information, making it difficult to compare candidates effectively.

After recording responses, the recruiter assesses whether the candidate's overall performance was positive or negative. This evaluation process introduces additional subjectivity, as different recruiters may have different criteria for determining a candidate's suitability. Without a standardized rating system or objective scoring mechanism, hiring decisions may be inconsistent, leading to potential bias and inefficiency in the selection process.

As shown, the technical limitations of this manual workflow are significant. It is difficult to scale, as recruiters can only handle a limited number of candidates at a time, causing bottlenecks when hiring demands increase. The process is also highly error-prone, with a reliance on manual data entry leading to inconsistencies, lost records, and miscommunication. Furthermore, it is inefficient, requiring recruiters to spend excessive time on repetitive tasks such as scheduling calls, tracking candidate responses, and updating records instead of focusing on strategic hiring decisions.

As recruitment needs grow in this digital age, these inefficiencies become more pronounced, slowing down the hiring cycle and negatively impacting the candidate experience.

However, implementing the AI-powered Recruiter (AIR) system presents several technical challenges that go beyond the limitations of traditional automated calls with boilerplate questions and scripted interactions. While basic interactive voice response (IVR) systems can handle a fixed set of questions and predictable response paths, they fail to utilize the power of large language models (LLMs) to dynamically adapt the conversation flow. This real-time adaptability is critical for accurately capturing a candidate's qualifications, detecting subtle cues in their responses, probing deeper in key areas of qualifications, and preventing manipulative behaviors. Relying on a single LLM-based agent to manage the entire conversation, however, can be problematic due to the model's receptiveness and vulnerability to being steered off-topic or misled by savvy users, compromising the interview's reliability and efficiency.

Another complexity lies in integrating additional functionalities necessary for a robust, compliant, and scalable screening process. For example, bias mitigation requires advanced techniques to detect and correct systemic or contextual biases within LLM-generated questions and evaluations. Data privacy mandates that personal information be securely handled at every stage of the conversation, including transcription, storage, and subsequent retrieval. Further, real-time guardrails must detect anomalies such as off-topic responses, language mismatches, or potential fraud, enabling the system to dynamically refine questions, terminate a session, or reschedule the interview. These requirements necessitate a modular architecture capable of supporting continuous updates to detection mechanisms, seamless integration with telephony infrastructure, and the capacity to handle high volumes of concurrent interviews without sacrificing performance or user experience.

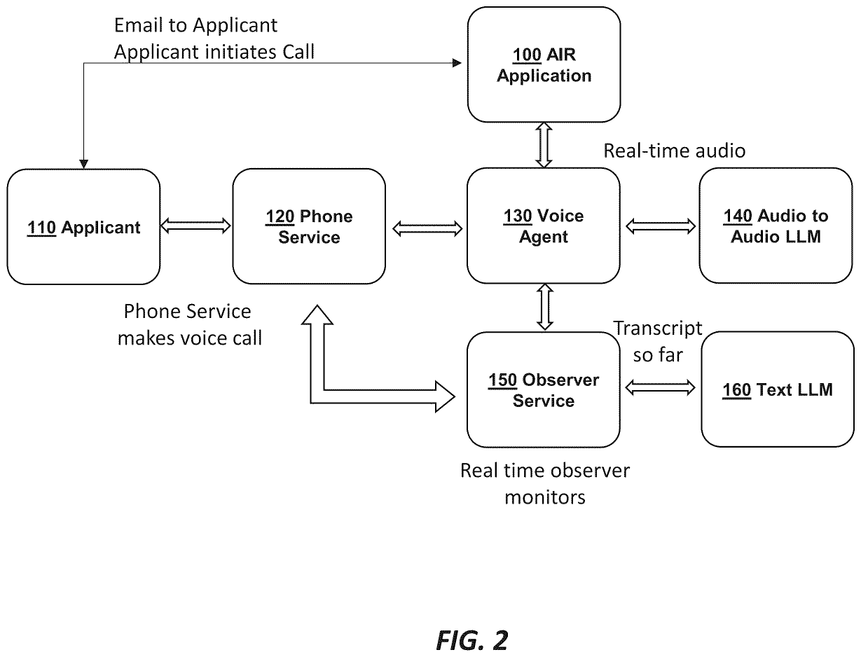

FIG. 2 illustrates an exemplary system diagram of AI-powered Recruiting (AIR) agent for automated screening, in accordance with some embodiments. The system comprises an AIR application 100 (e.g., a web application, a mobile application, or a desktop application), an Applicant or Candidate 110, a cloud-based Telephony Service 120, a Voice Agent 130, an Audio-to-Audio LLM 140, an Observer Service 150, and a Text LLM 160.

In some embodiments, the AIR application 100 is implemented as a secure, cloud-hosted web application accessible through standard web browsers. This design allows human recruiters to log in simultaneously from different locations, each accessing a shared interface that displays candidate lists, job openings, and real-time updates on ongoing screening sessions. Recruiters can initiate or review interview sessions directly from the web dashboard, monitor the status of ongoing calls, and manage applicant data in a cloud-based storage.

In some embodiments, the AIR application 100 initiates the screening process by sending an electronic message (e.g., email, SMS, or another suitable notification method) to the Applicant 110, containing a URL that allows the applicant to begin the interview session. Upon clicking the URL, the Applicant 110 triggers the AIR system to generate an API request to the cloud-based Telephony Service 120 responsible for establishing a real-time voice session with the Applicant 110. The cloud-based Telephony Service 120 dynamically provisions a call instance by allocating memory and computational resources based on current system load, ensuring that the system can efficiently scale and handle a large volume of concurrent interviews.

In some embodiments, the payload of the API request to the cloud-based Telephony Service 120 includes a call routing parameter, which directs the cloud-based Telephony Service 120 to connect the real-time voice session to the NLP-based Voice Agent 130. Upon receiving the call, the Voice Agent 130 retrieves an initial interview question from a cloud-based storage system, which contains a pre-generated question set tailored to the job opening and the candidate's profile. These interview questions are dynamically generated by the AIR system based on role-specific requirements and candidate data. Note that the pre-generated question set is optional and only used as a conversation starter, the substantive screening questions are generated on the fly by an Audio-to-Audio LLM 140.

Once the call is established, the Voice Agent 130 synchronizes the voice session with an Audio-to-Audio LLM-based AI agent 140, ensuring that candidate responses are continuously streamed in real-time for semantic processing and contextual understanding. The Audio-to-Audio LLM 140 generates AI-driven responses based on the candidate's voice input, which are then received by the Voice Agent 130. The Voice Agent 130 subsequently delivers these responses in real time to the Applicant 110, dynamically adjusting the interview flow based on detected context, speech patterns, and candidate engagement.

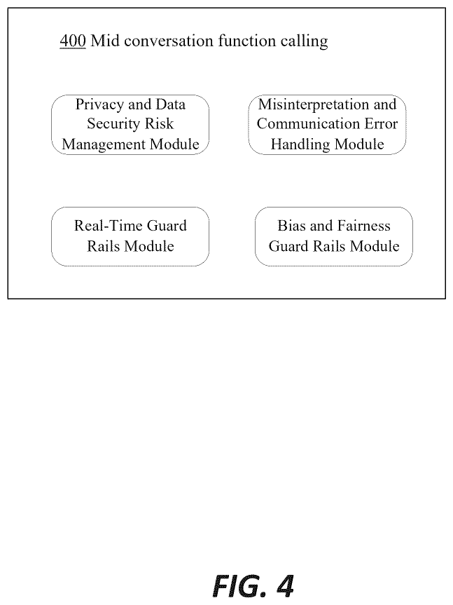

In some embodiments, the real-time voice session is also streamed to an Observer Service 150, which functions as an independent supervisory module responsible for monitoring conversation quality, consistency, and legitimacy. The Observer Service 150 operates as a parallel sidecar pipeline that continuously processes audio and text streams alongside the primary interview pipeline without interfering with the natural conversation flow. For example, the Observer Service 150 includes various function modules configured to construct queries to the LLM 160 along with the conversation transcript, and the queries are designed to ask the LLM 160 to evaluate the multiple configurable aspects of the conversation. The number and type of function modules within the Observer Service 150 are modular and extensible, allowing additional guardrails and function modules to be integrated based on system updates or evolving hiring requirements (further details in FIG. 4).

In some embodiments, if an anomaly is detected, the Observer Service 150 may generate a correction event, which is transmitted back to the LLM-based conversation engine in the form of a system-level prompt. Depending on the nature of the anomaly, this correction event may instruct the voice agent 130 to rephrase a question, ask for clarification, or reinforce conversational boundaries to prevent manipulation. In more severe cases, such as persistent voice inconsistencies indicative of fraudulent behavior, the Observer Service 150 may issue a re-routing command, shifting the candidate to an alternative screening method, such as a text-based interview for verification, or trigger an immediate session termination.

Fraud detection may extend beyond voice inconsistencies and include content-based fraud detection through an evaluation module integrated within the Observer Service 150. For example, the Observer Service 150 detects a likelihood that the candidate is unlikely to possess the numerosity of skills and experiences based on historical analyses of large amounts of employee and position pairings, and the module prompts detailed questions be asked to assess and adjust likelihood of the candidate's possession of expressed skills and experiences on the resumes.

To achieve this, the Observer Service 150 may extract semantic features from the candidate's responses using NLP models. These extracted features are then compared against a database of successful employee profiles for similar roles, analyzing the linguistic patterns and domain-specific knowledge typically demonstrated by qualified individuals. If the candidate's responses exhibit generic, inconsistent, or overly vague explanations that deviate significantly from expected industry norms, the system may flag the interaction as potentially fraudulent.

When a fraud likelihood threshold is exceeded, the Observer Service 150 can dynamically intervene by instructing the Voice Agent 130 to ask more detailed, role-specific follow-up questions. These questions are designed to probe technical depth, past work experiences, and problem-solving approaches in a way that challenges the authenticity of the candidate's claims. If the candidate's responses continue to demonstrate low specificity, conflicting statements, or evasion, the system may escalate the case for human review or trigger an adaptive verification process, such as requiring submission of additional documentation, text-based validation, or secondary interviews.

To maintain scalability and efficiency, the Observer Service 150 may employ batch processing for non-critical evaluations, ensuring that high-priority real-time assessments—such as fraud detection or off-topic monitoring-take precedence. Additionally, the system supports retrieval-augmented generation (RAG), where detected anomalies are cross-referenced against a structured knowledge base of expected candidate behaviors, linguistic norms, and job-specific competency models, further improving the accuracy and reliability of automated interventions.

The Observer Service 150 may be assigned with special override authority over the NLP-based voice agent 130, allowing it to supersede responses generated by the Audio-to-Audio LLM 140 when required. This ensures that conversation flow remains coherent, relevant, and resistant to manipulation. If the Observer Service 150 detects that the conversation has gone off track, exhibits suspicious behavior (e.g., multiple speakers detected within a session), or reveals inconsistencies in voice features, it dynamically injects corrective prompts to recalibrate the interview. In cases where a cumulative anomaly score surpasses a predefined termination threshold, the Observer Service 150 can escalate the session for human review, trigger a security verification process, or terminate the interview outright.

In this design, the Voice Agent 130 and Audio-to-Audio LLM 140 are primarily designed to process, understand, and respond to a candidate's voice input in a conversational manner. In addition to delivering AI-generated responses, the Voice Agent 130 is configured to handle special requests from the Applicant 110, such as rescheduling an interview, adjusting the speaking speed, or accommodating different accents for better accessibility. For example, upon receiving a rescheduling request, the Voice Agent 130 triggers an API call to the AIR web application 100, which then processes and confirms the new interview schedule.

Unlike the Voice Agent 130, the Observer Service 150 and Text LLM 160 are not designed to directly engage with the candidate but instead function as an independent evaluation mechanism to ensure that the conversation adheres to screening integrity standards. Specifically, they assess factors such as: whether the conversation remains relevant to the interview topic and follows the expected evaluation framework; whether the applicant's voice features (e.g., tone, speech pattern, frequency) remain consistent throughout the interaction, reducing the risk of fraudulent substitution; whether response latency and speech cadence remain natural, detecting irregularities that may indicate the use of unauthorized external assistance; and whether the quality of the audio remains stable, ensuring that communication barriers do not hinder the evaluation process.

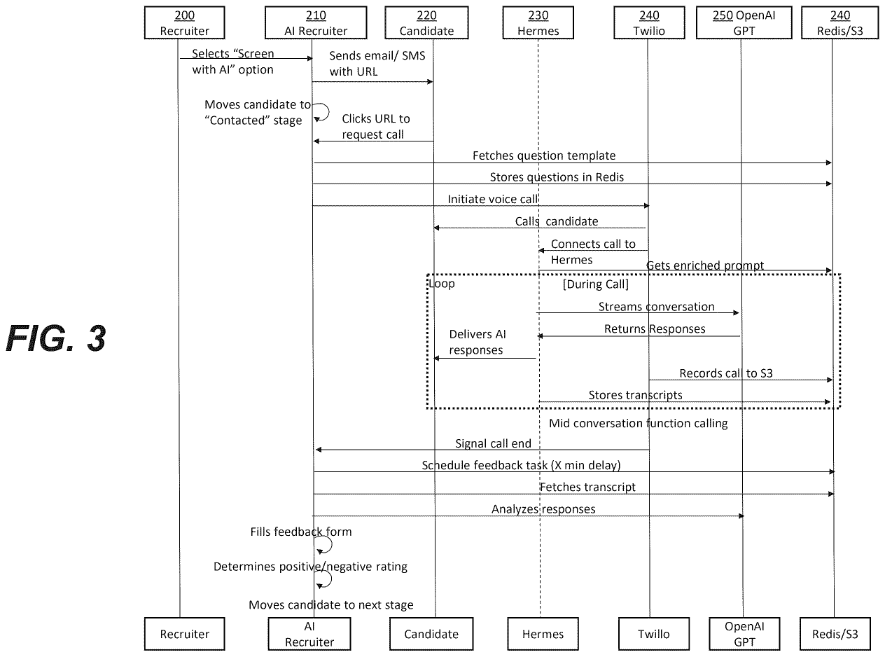

FIG. 3 illustrates an exemplary cross-functional diagram of automated screening using AIR, in accordance with some embodiments. The diagram illustrates sample interactions between different entities involved in the AI-powered automated screening process. The entities include a Recruiter 200 (human), AIR 210 (AI agent), Candidate 220 (human), Cloud-Based Telephony Platform 230, NLP-Based Voice Agent 240 (AI agent), LLM-Based Service 250 (AI agent), and a Cloud Storage 260.

In some embodiments, the process may begin when the Recruiter 200 initiates a screening request via the AIR 210 system by selecting a “screening with AI” option on the graphic user interface (GUI). The AIR 210 first generates a URL link for the candidate based on a job opening and the candidate's profile. This URL link is stored in a cloud-based storage system 260, along with associated metadata such as the job details, interview session expiration time, and candidate-specific evaluation criteria. Once the link is generated, AIR 210 transmits the unique interview link to the Candidate 220 through an electronic messaging system, such as email, SMS, or another suitable communication channel. The candidate 220 receives the notification and can initiate the interview process by clicking the provided link at his/her convenience.

When the candidate 220 clicks the link, a webhook listener in AIR 210 captures the interaction event, triggering the system to initiate a screening session. In response, AIR 210 retrieves the candidate's profile and job-related information from the cloud-based storage 260. Using this information, AIR 210 invokes a machine learning model to generate an interview question template specifically tailored to the job role and the candidate's profile. The system further customizes the interview question template based on the candidate's background and other stored metadata. Once the interview template is finalized, it is stored in the cloud storage 260 to ensure accessibility during the screening process.

With the interview template ready, AIR 210 triggers an API request to the cloud-based telephony platform 230 to establish a real-time voice session with the candidate 220. The telephony platform 230 dynamically allocates memory and computing resources to create a real-time voice session based on system load, ensuring that a large number of concurrent interviews can be supported efficiently. The API request may include a call routing parameter, instructing the telephony platform 230 to direct the voice session to the NLP-based voice agent 240. Once the call is connected, the NLP-based voice agent 240 retrieves the interview question template from cloud storage 260 and begins the interview.

As the interview progresses, the NLP-based voice agent 240 establishes a synchronized session with the LLM-based service 250 and continuously streams the candidate's responses in real time. The LLM-based service 250 processes the candidate's voice input, dynamically generating AI-driven responses that are transmitted back to the NLP-based voice agent 240 for delivery to the candidate 220. To enhance the accuracy and relevance of both responses and follow-up questions, the LLM-based service 250 integrates a Retrieval-Augmented Generation (RAG) system, which retrieves contextual information from a structured knowledge base comprising job descriptions, company policies, and role-specific qualifications.

For example, before generating a response, the LLM-based service 250 queries a vector database or other document storage system containing indexed company-specific information, job qualifications, and structured evaluation criteria. This retrieved data serves as an additional knowledge source, enabling the LLM-based service 250 to formulate responses or questions that align with the job requirements and organizational standards. The RAG system ensures that follow-up questions reflect the candidate's qualifications, previous responses, and the competencies required for the role, rather than relying solely on general knowledge embedded within the pretrained model.

During the conversation, the NLP-based voice agent 240 and LLM-based service 250 work in tandem to refine the dialogue. The candidate's responses are continuously analyzed, and if they indicate a need for clarification or deeper assessment (based on the semantic analysis of the candidate's voice response), the RAG-enhanced LLM 250 dynamically adjusts the interview strategy. For example, if a candidate mentions a specific skill or experience relevant to the role but was not previously included in the profile, the LLM-based service 250 can retrieve and integrate information from company-specific competency models to craft a targeted follow-up question. This process ensures that the interview remains context-aware, structured, and aligned with predefined hiring criteria, providing a more effective and AI-enhanced assessment of the candidate's suitability for the position. By incorporating real-time retrieval mechanisms, the LLM-based service 250 enhances its conversational capabilities beyond a generic language model, delivering job-specific, structured, and highly relevant interview interactions. This context awareness incorporates awareness of the job descriptions and specific criteria for the job positions for which the interviews are sought. The assessment can be based on the likelihood of the candidate possessing certain skills and experiences required or preferred by the job position, and be adjusted in question and answer flows dynamically to better probe skills or experiences or other qualifications (for example generating and asking multiple questions with different nuances surrounding a missing skill on the resume but likely skill for the candidate-job pair analysis, or a present skill on the resume but less likely skill for the candidate-job pair analysis) to better assess skill and experience matches. The assessment can skip over areas of questions if the confidence level for skill or experience match in a particular topic exceeds a threshold, devoting more time to other areas to better utilize the time of the conversation. The resulting adjustments to the likelihoods of skill and experience and overall matches can be passed back to the recruiter visually, and programmatically passed back to the recruitment evaluation modules to rank candidates in the context of relevant job positions. The evaluation module can be further conditioned to request additional follow-up interviews should certain areas of expertise receive a numeric evaluation scores that do not pass certain thresholds, but the overall matching evaluation exceeds certain threshold.

Simultaneously, the real-time voice session may be streamed to an observer module within AIR 210, which monitors the conversation for anomalies. This observer module is responsible for identifying issues such as off-topic responses, speech inconsistencies, language mismatches, and possible fraudulent behavior, such as multiple individuals attempting to answer on behalf of a single candidate. If an anomaly is detected, the observer module sends an overriding command to the NLP-based voice agent 240, instructing it to correct the course of the conversation or terminate the session if necessary.

During and after the interview, the real-time voice session is transcribed using a speech-to-text service, ensuring that all candidate responses are recorded in text format. Once the interview is completed, AIR 210 sends an asynchronous request to the LLM-based service 250 to analyze the transcribed conversation and generate an evaluation. Evaluation can be performed to match and predict likelihood to be hired and be successful in a job, for example ranking candidates using artificial intelligence techniques utilizing deep neural networks as disclosed in U.S. Pat. No. 10,803,421, which is incorporated herein by reference. The evaluation can be shown to the recruiter visually displaying key criteria, for examples skill-level matching and experience-level matching, and associated scoring for each and overall ranking score. That display is coupled with underlying matching adjustment, e.g. via matching API calls to adjust input parameters to a matching engine, to incorporate the information transcribed or learned from the conversation and the existing information prior to the interview about the requirements of the job and the candidate's application records. There can be a feedback loop between an evaluation module and AIR questioning generation. For example, if evaluation detects there remain a large amount of highly matched qualified candidates upon a large round of automated conversations by AIR, a second round of AIR conversations may be triggered to focus on newer questions that focus on key areas of job requirements that are less uniformly matched between the highly matched qualified candidates. The second and future rounds of AIR conversations may then be used to evaluate and differentiate on the top candidates. Different from the synchronized session for real-time conversation, this asynchronous request may be handled by the LLM 250 at down time (e.g., when the system load of the LLM 250 is below a threshold).

Upon completion of the screening process, AIR 210 deactivates the unique interview link stored in the cloud storage 260, preventing any further access or reuse. Finally, AIR 210 transmits the evaluation results to the recruiter 200, allowing them to review the AI-generated assessment and make informed hiring decisions.

FIG. 4 illustrates an exemplary set of functionalities implemented in the AIR system to enhance the quality, security, and efficiency of automated screening, in accordance with some embodiments. The mid-conversation function calling mechanism refers to the modularized functions and guardrails used by the observer service (e.g., 150 in FIG. 2) to analyze, adjust, and refine the live conversation between the candidate and the NLP-based voice agent. In some embodiments, the observer service is designed as a modular, extensible system, allowing integration of additional function plug-ins via an API framework. The API enables dynamically adding, removing, or modifying function plug-ins, allowing flexible adaptation to evolving detection needs. This structure ensures that new anomaly detection routines can be seamlessly integrated or deprecated without requiring a full system overhaul.

As shown in FIG. 4, AIR comprises four primary modules: the Privacy and Data Security Risk Management Module, the Misinterpretation and Communication Error Handling Module, the Real-Time Guard Rails Module, and the Bias and Fairness Guard Rails Module. Together, these modules enable continuous monitoring, anomaly detection, live intervention, and compliance with data privacy and fairness standards.

The observer service, in conjunction with the LLM-based AI agent, implements each module by generating structured prompts alongside the conversation transcript. These prompts serve as real-time evaluation requests, instructing the LLM to assess whether the candidate's responses remain relevant, whether speech patterns exhibit irregularities indicative of a disorder, and whether multiple speakers or artificial manipulations are present. To achieve this, the observer service continuously collects and processes conversation metadata, including timestamps, pauses, response latencies, and acoustic signals. When an anomaly detector identifies a potential issue, it formulates an evaluation prompt contextualizing the concern for the LLM. For example, if the observer detects an extended silence, it may append a prompt such as: “Analyze the following transcript for response hesitations exceeding the configured latency threshold. Does the candidate appear to be experiencing difficulty responding?” Similarly, if speech inconsistencies are detected, the observer may generate a prompt like: “Compare the voice patterns across different responses in the transcript. Do the phonetic characteristics suggest multiple speakers?” This structured evaluation allows the LLM to go beyond simple pattern matching and engage in higher-order reasoning to enhance the accuracy of anomaly detection.

To maintain efficiency, the observer service may employ batch processing, periodically submitting conversation segments to the LLM instead of processing them continuously in real-time. Since anomaly detection does not require absolute real-time analysis, a few seconds of delay is acceptable, ensuring that system resources remain available for real-time conversation processing. By prioritizing retrieval-augmented generation (RAG) queries for immediate conversational context while scheduling anomaly detection evaluations asynchronously, the system remains scalable, even when handling high interview volumes.

In some embodiments, the observer service includes a priority-based compliance check and/or anomaly detection mechanism, where function plug-ins specify their response priority through an API configuration. For example, high-priority plug-ins, such as fraud detection and response latency monitoring, can immediately transmit corrective prompts to the LLM-based AI agent, instructing it to modify the conversation structure in real time. Low-priority plug-ins, such as acoustic feature analysis for subtle speech impairments, may queue their findings for post-interview evaluation without disrupting the ongoing conversation. This prioritization mechanism ensures that immediate issues impacting conversation quality are addressed promptly, while non-urgent insights contribute to long-term evaluation and refinement of the candidate's responses.

In some embodiments, the observer service implements specialized plug-ins for off-topic response detection, speech irregularity analysis, and fraud detection. The off-topic response detector continuously evaluates whether candidate responses align with the structured inquiry template. If a deviation is detected, the observer service transmits a correction event, instructing the LLM-based AI agent to reframe the question or prompt the candidate for clarification. The speech pattern analyzer evaluates fluency by extracting mel-frequency cepstral coefficients (MFCCs), formant frequencies, and articulation rates to detect speech disfluencies such as prolonged pauses, hesitations, and irregular tempo. Meanwhile, the fraud detection module monitors biometric voice signatures and consistency patterns to detect unauthorized assistance, such as multiple speakers or artificial voice manipulation.

Upon detecting an anomaly, the observer service transmits a correction event to the LLM-based AI agent, incorporating system-level prompts that dynamically adjust the interview flow. If the detected anomaly pertains to a prolonged response latency, the observer service may instruct the NLP-based voice agent to rephrase the current question, simplify its phrasing, or prompt the candidate for additional clarification. If a fraud indicator, such as an unexpected voice signature mismatch, is detected, the system may escalate the issue by terminating the session or routing the candidate to an alternative verification step.

The Misinterpretation and Communication Error Handling Module further refines the screening process by analyzing the acoustic features of the candidate's voice input to detect communication impairments, such as speech disorders, hesitations, or inconsistencies that may affect the fairness of the assessment. The module leverages signal processing techniques and machine learning models to evaluate prosodic features of speech, including pitch, rhythm, tone, intensity, and speech fluency. By extracting mel-frequency cepstral coefficients (MFCCs), formants, and spectral envelope characteristics, the system can differentiate between natural speech variations and patterns indicative of communication difficulties.

Upon detecting irregularities, the system applies speech disfluency detection that classify hesitations, repetitions, and prolonged pauses in candidate responses. These checks compare the detected speech patterns against a baseline fluency model derived from large-scale linguistic datasets, enabling the system to distinguish between expected variations in speech and indicators of a potential speech disorder or nervousness. Additionally, tempo and articulation rate analysis is used to measure word per minute (WPM) ratios and assess whether the candidate speaks significantly slower or faster than expected for a fluent response.

When the system identifies communication challenges, it automatically triggers an accessibility accommodation mode, adjusting how questions are presented to the candidate. This may involve slowing the speech rate of the voice agent to improve intelligibility, simplifying question phrasing to reduce cognitive load, or switching to an alternative text-based communication mode for candidates who may find speech interactions difficult. If the system detects persistent speech irregularities.

The Real-Time Guard Rails Module tracks anomalies as they accumulate throughout the interview. Each detected issue is assigned a severity level, incrementing the candidate's overall anomaly score. If the total score surpasses a predefined threshold-due to repeated off-topic answers, suspicious voiceprints, or indications of fraud-the system may terminate the session and flag it for human review. This ensures that legitimate candidates facing technical or linguistic challenges are not unfairly penalized, while also preventing continued manipulation or abuse of the system.

While the Real-Time Guard Rails Module and the Misinterpretation and Communication Error Handling Module focus on live conversation management, the Bias and Fairness Guard Rails Module and the Privacy and Data Security Risk Management Module enforce broader governance measures. The Bias and Fairness Guard Rails Module continuously evaluates the system's prompts and assessments to mitigate biases present in training data, ensuring AI-generated responses remain neutral and objective. The Privacy and Data Security Risk Management Module safeguards candidate information by applying encryption, data access controls, and automated data expiration policies, preventing unauthorized retention or misuse of interview transcripts.

This parallel monitoring pipeline runs alongside the primary conversation, continuously analyzing candidate responses for off-topic deviations, speech inconsistencies, prolonged silences, and voice anomalies indicative of fraudulent behavior (e.g., multiple individuals answering on behalf of one candidate). When anomalies are detected, the observer service dynamically intervenes by instructing the NLP-based voice agent to rephrase a question, request clarification, or escalate a suspicious case for human review. Additionally, adaptive accessibility accommodations allow the system to identify speech impairments and adjust the interview delivery accordingly, such as slowing speech rate, simplifying question phrasing, or switching to a text-based interface.

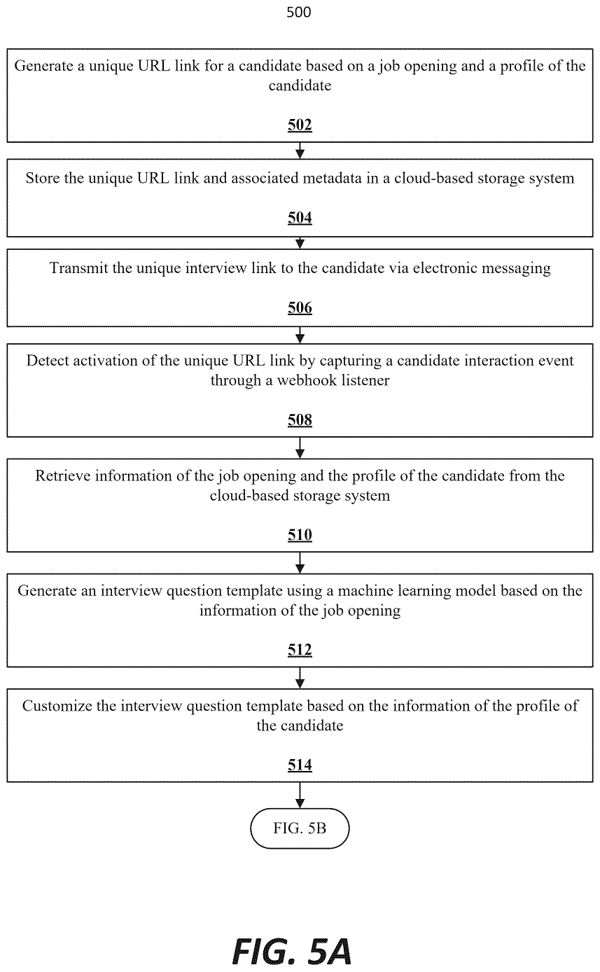

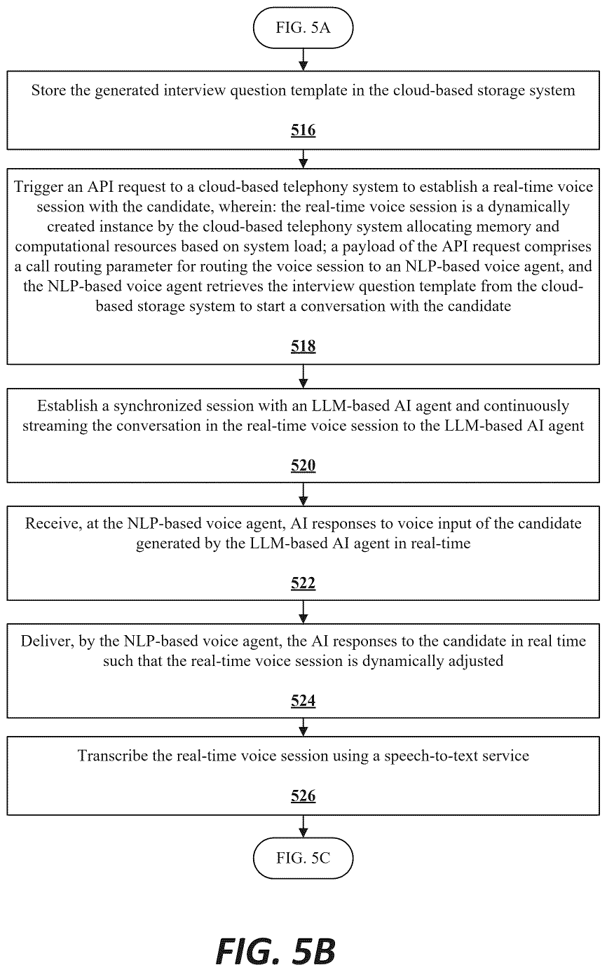

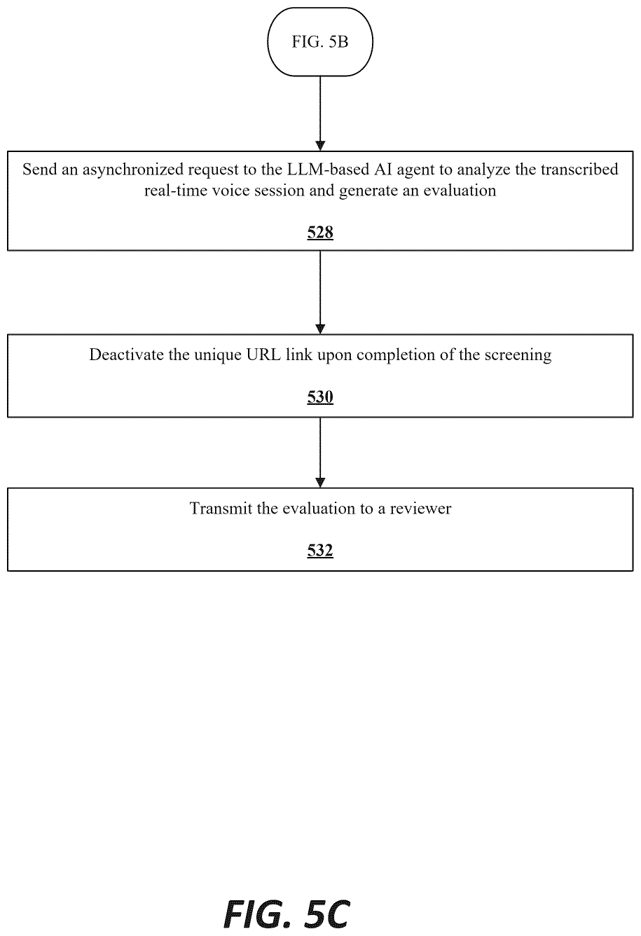

FIGS. 5A-5C is a flowchart of an exemplary process 500. In some implementations, one or more process blocks of FIGS. 5A-5C may be performed by a device.

As shown in FIGS. 5A-5C, process 500 begins with generating a unique URL link for a candidate based on a job opening and the candidate's profile (block 502). For example, a device may generate the unique URL link based on the job opening and profile details, as previously described. The process then includes storing the unique URL link and associated metadata in a cloud-based storage system (block 504). A device may store this information in the cloud-based storage system for later retrieval.

Process 500 further includes transmitting the unique interview link to the candidate via electronic messaging (block 506). The device may send this link through various messaging channels, such as email or SMS, allowing the candidate to initiate the interview process. Once the candidate activates the link, the system detects the activation event through a webhook listener (block 508). This detection allows the system to recognize when the candidate has engaged with the interview link.

Following activation, the system retrieves job-related information and the candidate's profile from the cloud-based storage system (block 510). Using this data, the system generates an interview question template with a machine learning model (block 512) to ensure that the interview is tailored to the specific job opening. The system then customizes the interview question template based on the candidate's profile (block 514), further refining the questions based on qualifications, experience, and role-specific requirements. Once generated, the interview question template is stored in the cloud-based storage system (block 516), ensuring it remains accessible throughout the screening process.

The system triggers an API request to a cloud-based telephony system to establish a real-time voice session with the candidate (block 518). The telephony system dynamically allocates memory and computational resources based on system load, creating a real-time voice session. The API request includes a call routing parameter directing the voice session to an NLP-based voice agent, which then retrieves the interview question template from the cloud-based storage system and begins the conversation with the candidate.

Once the interview session begins, the NLP-based voice agent establishes a synchronized session with an LLM-based AI agent and continuously streams the conversation in real time (block 520). The LLM-based AI agent processes the candidate's voice input and generates AI-driven responses, which are then transmitted back to the NLP-based voice agent (block 522). The NLP-based voice agent delivers AI-generated responses to the candidate in real time, dynamically adjusting the conversation flow based on detected nuances (block 524).

The conversation is transcribed in real time using a speech-to-text service (block 526), ensuring a textual record of the interview session. The transcribed text is then sent asynchronously to the LLM-based AI agent for analysis (block 528), where it generates an evaluation of the candidate's responses. Upon completion of the interview, the unique URL link is deactivated (block 530), preventing further access. Finally, the evaluation is transmitted to a reviewer for assessment (block 532).

Process 500 may also include additional implementations, such as performing specific tasks in parallel. In one implementation, while the conversation is continuously streamed to the LLM-based AI agent, it is also simultaneously streamed to an LLM-based observer service for real-time anomaly detection.

In another implementation, the LLM-based observer service comprises multiple anomaly detection microservices, each configured to assess different aspects of the conversation. These microservices may include an off-topic response detector, which determines whether the candidate's responses deviate from the expected interview structure, a speech pattern analyzer, which identifies speech disorders or inconsistencies that impact the candidate's ability to respond effectively, and a fraud detection module, which detects multiple speakers or inconsistencies in voice characteristics indicative of unauthorized assistance.

In yet another implementation, when the LLM-based observer service detects an anomaly, it transmits a correction event to the LLM-based AI agent, modifying the conversation flow in real time. The correction event may instruct the AI agent to clarify a candidate's off-topic response, rephrase a question, or prompt for further verification.

Further, the LLM-based observer service applies a pre-configured response latency threshold to ensure candidates have sufficient time to answer. If the system detects a prolonged pause, it instructs the NLP-based voice agent to either rephrase the question or prompt the candidate for clarification.

In another implementation, the LLM-based observer service evaluates acoustic features of the candidate's voice input. If it detects a speech disorder or communication impairment, it triggers an accessibility accommodation mode, adjusting the speech rate, simplifying question phrasing, or providing an alternative text-based response option.

In a further implementation, the LLM-based observer service applies a dynamic scoring mechanism to detected anomalies, assigning severity levels to each issue. If the cumulative anomaly score exceeds a predefined threshold—indicating fraudulent behavior or non-cooperation—the system may terminate the interview or escalate it for human review.

Although FIGS. 5A-5C depict specific process blocks, in some implementations, process 500 may include additional, fewer, or differently arranged blocks, depending on system configuration. Additionally, two or more of the blocks may be executed in parallel, ensuring an efficient and scalable screening process.

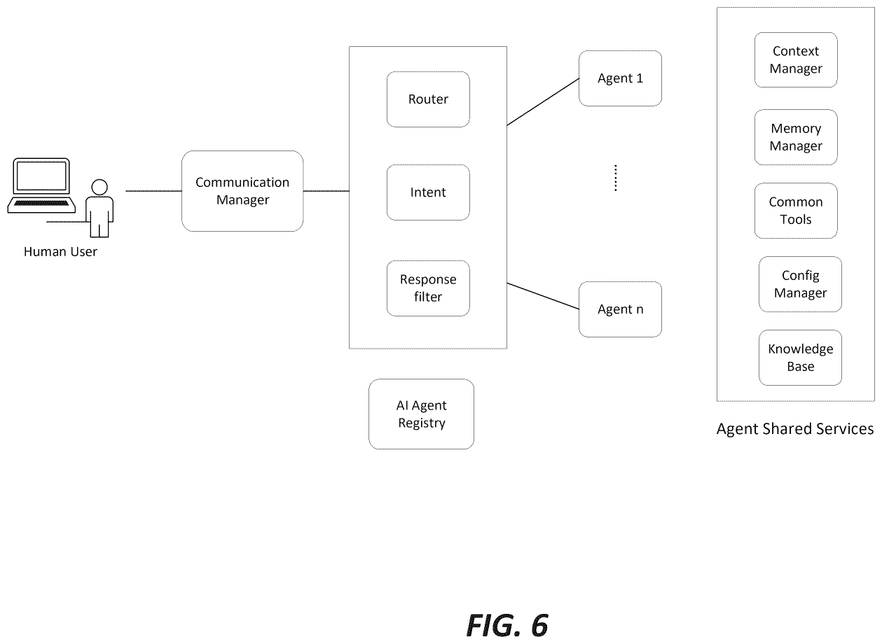

FIG. 6 illustrates an example AIR architecture in which the above-mentioned AIR agent is deployed, in accordance with some embodiments. The architecture includes a multi-agent system that enables automated recruitment workflows by coordinating AI-driven tasks across different stages of the hiring process.

As shown, at the front, a communication manager serves as the unified interface for interacting with human users across various collaboration platforms, such as Slack, Microsoft Teams, Email, and SMS. This modular design ensures that the underlying AI agent logic remains insulated from the medium of communication, allowing the full functionality of the system to be seamlessly available regardless of the user's chosen platform. The communication manager receives user input and processes it before routing it to the appropriate AI agents.

Between the communication manager and the AI agent layer, the system may include a set of bridging tools that facilitate the interaction between human inputs and AI-driven processes. One such tool is an intent-prediction AI model, which determines whether a user request corresponds to creating a job opening, modifying an existing listing, or adjusting required skill sets. Since user inputs may be in natural language, this intent-prediction model may be implemented as an LLM-based AI agent capable of extracting and classifying the intent of incoming requests. Additionally, the system may include a response filter, which formats and standardizes user input data before forwarding it to the AI agents for further processing.

The AI agents layer consists of a set of autonomous agents, each responsible for a specific function within the recruitment process. These agents are all registered in an agent registry, which stores identifiers, APIs, and libraries associated with each AI agent, allowing the communication manager to locate and trigger AI agents as needed. This agent registry acts as a directory service, ensuring that various AI-driven components can seamlessly integrate and communicate.

In this architecture, each AI agent is designed to handle a specific task within the recruitment pipeline. For example, a sourcing agent may be responsible for identifying and adding qualified candidates to the pipeline using tools such as outreach emails, campaign management, and virtual recruiting events. The screening agent (AIR agent, as described in FIGS. 1-5C) automates the candidate screening process by conducting structured AI-driven interviews, evaluating responses, and generating recruiter-ready assessments.

For the recruitment pipeline to function efficiently, the system needs to solve an optimization problem that ensures timely progress toward hiring goals. For example, if a company aims to hire a candidate within 30 days, the system must plan backward, ensuring that four final-round interviews occur within 25 days, which in turn requires 200 applicants screened within the first 10 days, and so on. Unlike a human recruiter who can manually adjust and balance different stages of the process based on bottlenecks, this multi-agent system must coordinate autonomously, ensuring that delays in one stage do not impact downstream outcomes.

To facilitate this coordination, the system may define clear contracts specifying the precise set of actions each AI agent can be asked to perform. For instance, in response to a detected bottleneck, an upstream agent may receive an adjustment request, such as “Increase the number of applicants with public speaking skills in Chicago.” These structured requests ensure that agents communicate effectively and autonomously adjust their tasks without requiring constant human intervention.

In some embodiments, the system may deploy a master agent, or requisition agent, for coordination, which monitors key pipeline metrics and translates any necessary changes into structured instructions for the relevant AI agents. This requisition agent enables adaptive pipeline optimization, ensuring that the system remains dynamic, self-adjusting, and capable of meeting hiring goals efficiently.

To make the system scalable, the AI agents share a set of tools that provide common functionalities, ensuring efficient communication, consistency, and adaptability across different AI-driven recruitment tasks. These shared tools allow AI agents to focus on their core functions while leveraging a unified infrastructure to handle memory, privacy, configuration, and knowledge management. This modular design enhances the scalability and flexibility of the system, allowing users to build customized AI agents tailored to their specific needs.

An example shared tools is the Context Manager, which maintains conversation history, chats, threads, and related interactions. By storing and managing past interactions, the Context Manager enables continuity in AI-driven conversations, allowing agents to retain context across multiple engagements with a user.

Another example shared tool is the Privacy Manager that ensures responses are uniformly curated for privacy compliance. This module is responsible for redacting sensitive information before returning responses to users, ensuring that personal, confidential, or legally protected data is not exposed.

To improve personalization, the Memory Manager may be configured to extract information from conversations to build a profile of user preferences. This allows the AI agents to adapt their responses based on user behavior, such as preferring early morning meetings over afternoon slots or consistently selecting specific candidate attributes.

In some embodiments, the tools may further include a Knowledge Base, which can be implemented as the RAG described above. The Knowledge Base allows AI agents to access, retrieve, and integrate structured and unstructured information from internal and external data sources. This enhances the AI agents' ability to answer user queries accurately, generate role-specific responses, and continuously improve decision-making based on evolving information.

To facilitate system-wide configuration and adaptability, a Config Manager may be configured to manage system settings, parameters, and hyperparameters. This module enables dynamic tuning of AI models and recruitment processes, allowing administrators to adjust system behavior without modifying core AI agent logic.

Additionally, Common Tools may provide essential functionalities such as user interfaces (UI), alerts, and notifications, ensuring that human recruiters and AI agents remain informed and aligned throughout the recruitment workflow. These tools support real-time monitoring, automated status updates, and interactive dashboards, making it easier for users to track AI-driven processes and intervene when necessary.

Depending on the implementation, the AIR system may include several built-in AI agents, such as the screening AIR described in FIGS. 1-5C, along with additional agents for job creation, sourcing, interviewing, offers, and onboarding.

For example, the job creation AIR may be trained and fine-tuned to streamline and automate the process of defining and finalizing hiring requirements. It assists hiring managers and recruiters by generating structured job descriptions, coordinating stakeholder input, and ensuring alignment across different teams.

Once a hiring requirement draft is generated, the job creation AIR can automatically send email or chat notifications to relevant hiring managers and team leads. These notifications provide a summary of the job requirements and include a link to review and modify the details.

During the calibration step, the job creation AIR facilitates real-time collaboration between hiring managers and team members. Through integrations with platforms such as Microsoft Teams or in-platform collaboration tools, users can review and refine the hiring document, adding specific skill requirements, role expectations, and department-specific needs.

Once the job requirements are finalized, the job creation AIR can generate a structured interview plan tailored to the role. Using predefined templates, historical hiring data, and competency frameworks, it defines interview stages, assigns interviewers, and suggests key questions and evaluation criteria.

For approvals, the job creation AIR automates the review and approval process by notifying approvers via email, task management systems, Microsoft Teams, or mobile push notifications.

As another example, the sourcer AIR may be configured to proactively manage the candidate pipeline, ensuring that sourcing efforts remain aligned with hiring goals and urgency. By leveraging automated outreach, job posting optimization, and event management, the sourcer AIR helps recruiters maintain a steady flow of qualified candidates while minimizing manual effort. Using real-time data and predictive analytics, the sourcer AIR can prioritize sourcing efforts, ensuring that high-priority roles receive immediate attention while maintaining engagement with passive candidates for future hiring needs.

Once a job opening is approved, the sourcer AIR can automatically publish the listing on job sites and notify hiring managers when the posting goes live. These notifications may include direct links to the job postings, performance tracking dashboards, and estimated reach metrics, allowing recruiters to monitor the visibility and engagement of each listing. Additionally, the AIR can automate periodic performance updates, alerting hiring teams about candidate responses, application trends, and any required adjustments to sourcing strategies.

Beyond passive job postings, the sourcer AIR actively engages potential candidates through automated outreach campaigns, event planning, and personalized invitations. Using AI-driven communication tools, the system can execute targeted candidate outreach campaigns, sending personalized emails, SMS messages, or chat notifications to encourage applications. Additionally, for high-volume hiring, the AIR can coordinate virtual or in-person recruitment events, handling the invitation process, scheduling, and follow-up communications. The AIR can also identify passive candidates who match the role criteria and send personalized “invite to apply” emails, increasing the pool of potential applicants without requiring manual sourcing efforts.

The sourcer AIR also serves as a centralized information hub for interview preparation, ensuring that recruiters, hiring managers, and interviewers have consistent, up-to-date details about candidates and interview requirements. The AIR can aggregate and provide key information, including candidate background summaries, interviewer profiles, and focus areas for evaluation, streamlining the preparation process.

As yet another example, a scheduling AIR may be built to automate and optimize the process of scheduling, coordinating, and managing interviews across multiple stakeholders.

In some embodiments, the scheduling AIR fully automated the interview setup process, allowing recruiters to trigger interview scheduling through a centralized scheduling platform. With the scheduling AIR, candidates receive a customized scheduling link that enables them to select interview slots at their convenience, while ensuring that the selected time aligns with interviewer availability. To prevent scheduling conflicts or delays, the scheduling AIR dynamically configures expiration rules for the scheduling link, clearly displaying deadlines for candidate selection. These expiration timelines can be globally defined and adjusted based on organizational hiring policies, ensuring flexibility across different recruitment scenarios.

One of the key advantages of the scheduling AIR is its ability to handle last-minute changes and rescheduling requests without requiring recruiter intervention. The AIR continuously monitors interviewer and candidate availability and, in the event of a conflict, automatically updates the schedule, notifies all affected parties, and ensures real-time synchronization across calendars and communication tools.

Beyond scheduling logistics, the scheduling AIR can also facilitate AI-driven initial screenings. For early-stage interviews, the AIR can autonomously conduct structured candidate assessments, using predefined question templates, evaluation criteria, and conversational AI models. This allows recruiters to filter out unqualified candidates before live interviews, ensuring that hiring teams focus only on the most promising applicants.

For technical and functional interviews, the AI agent can be fine-tuned to align with specific job requirements. Recruiters and hiring managers can customize question sets, benchmarks, and assessment criteria in advance, allowing the AIR to conduct role-specific AI-driven interviews. The AIR can analyze candidate responses in real-time, adjusting the difficulty and flow of questions dynamically based on candidate performance.

Following each interview, the interview scheduling AIR automates post-interview feedback collection, ensuring structured evaluation from interviewers. The system gathers feedback through interactive forms, text inputs, or voice notes, organizing responses into structured reports that highlight candidate strengths, weaknesses, and key insights. For AI-driven interviews, the AIR generates detailed performance summaries, including metrics, transcripts, and AI-driven insights, which are then sent to hiring teams for review.

As yet another example, onboarding AIR may be built to automate and streamline the post-hiring process, ensuring a seamless transition from offer acceptance to full integration within the company.

One of the key functionalities of the onboarding AIR is data collection from candidates. Upon acceptance of an offer, the onboarding AIR automatically initiates the process of gathering required personal and professional information, such as legal documentation, tax forms, and employment eligibility verification.

The offer management module within the onboarding AIR assists hiring teams by providing data-driven offer recommendations and approvals. By analyzing historical offer data, market compensation trends, and the candidate's current salary information, the AIR can suggest competitive compensation packages that align with company policies and industry benchmarks.

For candidate communication, the onboarding AIR includes an offer explainer module, functioning as an AI-powered FAQ assistant. Candidates can interact with the AI agent to ask questions about salary structures, benefits, company policies, and other employment terms. This reduces the need for recruiters or HR representatives to manually respond to routine inquiries, while ensuring that candidates receive accurate, consistent, and real-time responses.

To ensure compliance and readiness for employment, the background verification module within the onboarding AIR can automatically initiate pre-employment screenings, such as criminal record checks, reference verifications, and document validation. The onboarding AIR integrates with third-party verification services to track progress, notify candidates of pending actions, and update recruiters upon successful completion of the verification process.

Beyond offer acceptance, the onboarding AIR may also facilitate a structured onboarding experience by curating personalized recommendations for new hires. The AI agent can suggest training courses, orientation sessions, and company-specific learning modules tailored to the employee's role, department, and experience level. Additionally, it serves as a company explainer, providing organizational overviews, cultural insights, and key contact information to help new employees integrate seamlessly.

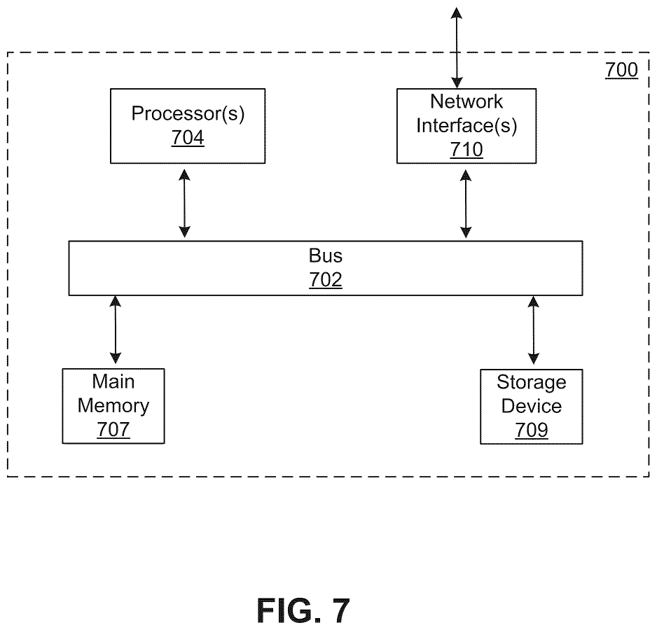

FIG. 7 illustrates an example computing device in which any of the embodiments described herein may be implemented. The computing device may be used to implement one or more components of the systems and the methods shown in FIGS. 1-5. The computing device 700 may comprise a bus 702 or other communication mechanisms for communicating information and one or more hardware processors 704 coupled with bus 702 for processing information. Hardware processor(s) 704 may be, for example, one or more general-purpose microprocessors.

The computing device 700 may also include a main memory 707, such as a random-access memory (RAM), cache, and/or other dynamic storage devices, coupled to bus 702 for storing information and instructions to be executed by processor(s) 704. Main memory 707 also may be used for storing provisional variables or other intermediate information during the execution of instructions to be executed by processor(s) 704. Such instructions, when stored in storage media accessible to processor(s) 704, may render computing device 700 into a special-purpose machine that is customized to perform the operations specified in the instructions. Main memory 707 may include non-volatile media and/or volatile media. Non-volatile media may include, for example, optical or magnetic disks. Volatile media may include dynamic memory. Common forms of media may include, for example, a floppy disk, a flexible disk, hard disk, solid-state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, or networked versions of the same.

The computing device 700 may implement the techniques described herein using customized hard-wired logic, one or more ASICs or FPGAs, firmware and/or program logic which in combination with the computing device may cause or program computing device 700 to be a special-purpose machine. According to one embodiment, the techniques herein are performed by computing device 700 in response to processor(s) 704 executing one or more sequences of one or more instructions contained in main memory 707. Such instructions may be read into main memory 707 from another storage medium, such as storage device 709. Execution of the sequences of instructions contained in main memory 707 may cause processor(s) 704 to perform the process steps described herein. For example, the processes/methods disclosed herein may be implemented by computer program instructions stored in main memory 707. When these instructions are executed by processor(s) 704, they may perform the steps as shown in corresponding figures and described above. In alternative embodiments, hard-wired circuitry may be used in place of or in combination with software instructions.

The computing device 700 also includes a communication interface 710 coupled to bus 702. Communication interface 710 may provide a two-way data communication coupling to one or more network links that are connected to one or more networks. As another example, communication interface 710 may be a local area network (LAN) card to provide a data communication connection to a compatible LAN (or WAN component to communicate with a WAN). Wireless links may also be implemented.

Certain operations may be performed in a distributed manner among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Each process, method, and algorithm described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor-executable non-volatile computer-readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be composed in program codes or instructions stored in a memory (e.g., a non-transitory computer-readable storage medium described above). Such an algorithm may comprise a machine learning algorithm. In some embodiments, a machine learning algorithm may not explicitly program computers to perform a function but can learn from training data to make a prediction model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

Certain of the operations may be performed in a distributed manner among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is in fact disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The terms “include” or “comprise” are used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A method for AI-based automated conversation conduction, comprising:
generating a URL link for a client device associated with an end user;
storing the URL link and associated metadata in a storage system;
transmitting the URL link to the client device via electronic messaging;
detecting activation of the URL link by capturing an interaction event on the URL link through a webhook listener;
retrieving selection criteria and subject-specific attributes of the end user from the storage system;
generating a structured inquiry template using a machine learning model based on the selection criteria;
customizing the structured inquiry template based on the subject-specific attributes of the end user;
storing the structured inquiry template in the storage system;
triggering a request to a telephony system to establish a real-time voice session with the end user, wherein:
the real-time voice session is a dynamically created instance by the telephony system allocating memory and computational resources based on system load;
a payload of the request comprises a call routing parameter for routing the real-time voice session to an NLP-based voice agent, and
the NLP-based voice agent retrieves the structured inquiry template from the storage system to start an automated conversation with the end user;
establishing a synchronized session between the NLP-based voice agent and an LLM-based AI agent, and continuously streaming the conversation in the real-time voice session to the LLM-based AI agent;
receiving, at the NLP-based voice agent, AI responses to voice input of the end user generated by the LLM-based AI agent in real-time;
delivering, by the NLP-based voice agent, the AI responses to the end user in real time such that the real-time voice session is dynamically adjusted;
transcribing the real-time voice session using a speech-to-text service;
sending an asynchronized request to the LLM-based AI agent to analyze the transcribed real-time voice session and generate an evaluation;
deactivating the URL link upon completion of the real-time voice session; and
transmitting the evaluation to a reviewer.

2. The method of claim 1, further comprising:
in parallel with the continuously streaming of the conversation in the real-time voice session to the LLM-based AI agent, streaming the conversation in the real-time voice session to an LLM-based observer service for compliance check.

3. The method of claim 2, wherein:
the LLM-based observer service is implemented as a sidecar process with APIs for dynamically adding, removing, or modifying function plug-ins, each function plug-in defining one or more anomaly detection routines, and
the APIs comprise a parameter for configuring a priority of each function plug-in, the parameter indicating whether, upon detecting an anomaly associated with the function plug-in, alerts or superseding prompts should be injected into the real-time voice session or handled asynchronously without interrupting the real-time voice session.

4. A system, comprising one or more processors and one or more non-transitory computer-readable memories coupled to the one or more processors and configured with instructions executable by the one or more processors to cause the system to perform operations comprising:
upon detecting activation of the URL link provided to an end user, triggering a request to a telephony system to establish a real-time voice session with the end user, wherein the telephony system routes the real-time voice session to an NLP-based voice agent;
establishing a synchronized session between the NLP-based voice agent and an LLM-based AI agent, wherein the LLM-based AI agent generates AI responses to voice input of the end user for delivery to the end user via the NLP-based voice agent; and
evaluating, using the LLM-based AI agent, the real-time voice session as transcribed by a speech-to-text service.

5. The system of claim 4, wherein the operations further comprise:
streaming the real-time voice session to an LLM-based observer service for compliance check, wherein the LLM-based observer service is implemented as a sidecar process with APIs for dynamically adding, removing, or modifying function plug-ins, each function plug-in defining one or more compliance check routines.

6. The system of claim 5, wherein the compliance check routines comprise anomaly detection routines, and the operations further comprise:
upon detecting an anomaly, transmitting, by the LLM-based observer service, a correction prompt to the LLM-based AI agent causing the LLM-based AI agent to modify the AI responses in real-time.

7. The system of claim 5, wherein the operations further comprise:
upon detecting a pause in the end user's response beyond a pre-configured response latency threshold, transmitting an instruction to the NLP-based voice agent to rephrase a question output by the NLP-based voice agent or prompt the end user for clarification.

8. The system of claim 5, wherein the LLM-based observer service applies a dynamic scoring mechanism to classify detected anomalies by severity levels, and the operations further comprise:
upon determining that a cumulative anomaly score exceeds a predefined threshold, terminating the real-time voice session or escalating the real-time voice session for human review.

9. The system of claim 5, wherein the APIs of the LLM-based observer service comprise a parameter for configuring a priority of each function plug-in, the parameter indicating whether, upon detecting an anomaly associated with the function plug-in, alerts or superseding prompts should be injected into the real-time voice session or handled asynchronously without interrupting the real-time voice session.

10. The system of claim 4, wherein the operations further comprise:
upon detecting impairments or inconsistencies in the end user's speech, modifying voice output by adjusting a speaking rate, simplifying question phrasing, or offering a text-based alternative.

11. The system of claim 4, wherein the real-time voice session is a dynamically created instance by the telephony system allocating memory and computational resources based on system load.

12. The system of claim 4, wherein a payload of the request comprises a call routing parameter for routing the real-time voice session to an NLP-based voice agent.

13. The system of claim 4, wherein the operations further comprise:
retrieving, using the NLP-based voice agent, a structured inquiry template from a storage system to start an automated conversation with the end user.

14. A method for AI-based automated conversation conduction, comprising:
upon detecting activation of the URL link provided to an end user, triggering a request to a telephony system to establish a real-time voice session with the end user, wherein the telephony system routes the real-time voice session to an NLP-based voice agent;
establishing a synchronized session between the NLP-based voice agent and an LLM-based AI agent, wherein the LLM-based AI agent generates AI responses to voice input of the end user for delivery to the end user via the NLP-based voice agent; and
evaluating, using the LLM-based AI agent, the real-time voice session as transcribed by a speech-to-text service.

15. The method of claim 14, further comprising:
streaming the real-time voice session to an LLM-based observer service for compliance check, wherein the LLM-based observer service is implemented as a sidecar process with APIs for dynamically adding, removing, or modifying function plug-ins, each function plug-in defining one or more compliance check routines.

16. The method of claim 15, wherein the compliance check routines comprise anomaly detection routines, and the method further comprises:
upon detecting an anomaly, transmitting, by the LLM-based observer service, a correction prompt to the LLM-based AI agent causing the LLM-based AI agent to modify the AI responses in real-time.

17. The method of claim 15, further comprising:
upon detecting a pause in the end user's response beyond a pre-configured response latency threshold, transmitting an instruction to the NLP-based voice agent to rephrase a question output by the NLP-based voice agent or prompt the end user for clarification.

18. The method of claim 14, wherein the real-time voice session is a dynamically created instance by the telephony system allocating memory and computational resources based on system load.

19. The method of claim 14, wherein a payload of the request comprises a call routing parameter for routing the real-time voice session to an NLP-based voice agent.

20. The method of claim 14, further comprising:
retrieving, using the NLP-based voice agent, a structured inquiry template from a storage system to start an automated conversation with the end user.
